(19) United States
(12) Patent Application Publication
(10) Pub. No.: US 2011/0219373 A1
(43) Pub. Date: Sep. 8, 2011

(54) VIRTUAL MACHINE MANAGEMENT APPARATUS AND VIRTUALIZATION METHOD FOR VIRTUALIZATION-SUPPORTING TERMINAL PLATFORM

(75) Inventors: Ki-Hyuk Nam, Daejeon (KR); Kang Ho Kim, Daejeon (KR); SooCheol Oh, Daejeon (KR); Kwang-Won Koh, Daejeon (KR)

(73) Assignee: Electronics and Telecommunications Research Institute, Daejeon (KR)

(21) Appl. No.: 13/037,708

(22) Filed: Mar. 1, 2011

(30) Foreign Application Priority Data
Mar. 2, 2010 (KR) 10-2010-0018438
Aug. 23, 2010 (KR) 10-2010-0081237

(51) Int. Cl. G06F 9/455

(52) U.S. Cl. 718/1

(57) ABSTRACT

A virtual machine management apparatus includes a first Operating System (OS) kernel for supporting a first OS that runs on a virtualization-supporting terminal platform; and a second OS kernel for supporting a second OS that runs on the terminal platform. Further, the virtual machine management apparatus includes a virtual machine configuration manager for, when an exception task is requested based on the first OS or the second OS of the terminal platform, controlling processing of the exception task in compliance with a preset policy.

### CROSS-REFERENCE TO RELATED APPLICATION(S)

The present invention claims priority of Korean Patent Application No. 10-2010-0018438, filed on Mar. 2, 2010, and Korean Patent Application No. 10-2010-0081237, filed on Aug. 23, 2010, which are incorporated herein by references.

### FIELD OF THE INVENTION

The present invention relates to a virtualization method for a terminal platform that supports virtualization, and, more particularly, to a virtual machine management apparatus and virtualization method for a virtualization-supporting terminal platform, which are configured to maximally utilize a virtualization-supporting hardware function provided by a target platform depending on the characteristics of the entire system in a small-sized terminal platform that supports virtualization in a hardware manner, thus optimizing the performance of a number of guest Operating Systems (OSs) identical to the number of virtual Central Processing Units (CPUs) provided by the terminal platform, and minimizing the size of the virtual machine management apparatus.

### BACKGROUND OF THE INVENTION

Generally, virtualization technology refers to a technology for enabling one type of Operating System (OS) to be used inside another type of OS.

That is, virtualization technology is implemented such that a hypervisor for forming a virtualization layer on a host OS or directly providing the virtualization layer to the host OS is provided, and such that a plurality of logical virtual machines are generated within the virtualization layer. In this case, on the plurality of virtual machines, guest OSs may be respectively installed, and applications supported by the corresponding guest OSs may be installed on the respective guest OSs.

Such a virtualization technology has been mainly used in the server computing field, but there has recently been a trend to apply it to mobile devices such as mobile phones.

In this case, the above-described virtualization technology is classified into para-virtualization that requires modification of a guest OS from the standpoint of a virtualization technique, and full-virtualization that can be used without requiring modification of a guest OS. In the case of most small-sized terminals, technology based on the former is mainly employed.

However, a conventional virtual machine management apparatus is disadvantageous in that the performance thereof is inevitably degraded due to its structural characteristics whereby the number of resources provided in a hardware manner is caused to increase in a software manner and then a plurality of OSs must share the resources. Further, additional expenses are required to modify the sources of a guest OS in conformity with a virtual machine management software module for the purpose of improving the efficiency of the virtual machine management software module.

### SUMMARY OF THE INVENTION

In view of the above, the present invention provides a virtual machine management apparatus and virtualization method for a virtualization-supporting terminal platform, which are configured to maximally utilize a virtualization-supporting hardware function provided by a target platform depending on the characteristics of the entire system in a small-sized terminal platform that supports virtualization in a hardware manner, thus optimizing the performance of a number of guest OSs identical to the number of virtual CPUs provided by the terminal platform, and minimizing the size of the virtual machine management apparatus.

In accordance with a first aspect of the present invention, there is provided a virtual machine management apparatus. The virtual machine management apparatus includes a first Operating System (OS) kernel for supporting a first OS that runs on a virtualization-supporting terminal platform; a second OS kernel for supporting a second OS that runs on the terminal platform; and a virtual machine configuration manager for, when an exception task is requested based on the first OS or the second OS of the terminal platform, controlling processing of the exception task in compliance with a preset policy.

In accordance with a second aspect of the present invention, there is provided a virtual machine management apparatus, including: a first Operating System (OS) kernel for supporting a first OS that runs on a virtualization-supporting terminal platform; a second OS for supporting a second OS that runs on the terminal platform; and a virtual machine configuration manager for, when execution of any task is requested based on the first OS or the second OS of the terminal platform, the task is allocated to and processed by the first OS or the second OS in compliance with a scheduling policy preset for the first OS or the second OS.

In accordance with a third aspect of the present invention, there is provided a virtualization method using a virtual machine management apparatus, including: a terminal platform, which supports virtualization of a first Operating System (OS) and a second OS, receiving an execution task request; allocating the exception task to the first OS or the second OS in compliance with a preset policy when the exception task request is received; and executing the execution task based on the first OS or the second OS to which the exception task has been allocated.

In accordance with a fourth aspect of the present invention, there is provided a virtualization method using a virtual machine management apparatus, including: a terminal platform, which supports virtualization of a first Operating System (OS) and a second OS, receiving any task request; inspecting a scheduling policy preset for the first OS or the second OS when the task request is received; allocating the task to the first OS or the second OS in compliance with the scheduling policy; and executing the task based on the OS to which the task has been allocated.

In accordance with an embodiment of the present invention, it is configured to maximally utilize a virtualization-supporting hardware function provided by a target platform depending on the characteristics of the entire system in a small-sized terminal platform that supports virtualization in a hardware manner. Accordingly, the performance of a number of guest OSs identical to the number of virtual CPUs provided by the terminal platform can be optimized, and the size of the virtual machine management apparatus can be minimized.

That is, the number of usable OSs is limited to two, and ARM TrustZone and the virtualization-supporting hardware of a terminal platform, similar to the ARM TrustZone, are maximally utilized, thus improving the performance and reducing the complexity and size of a virtual machine management apparatus compared to a conventional virtual machine management apparatus.

### BRIEF DESCRIPTION OF THE DRAWINGS

The objects and features of the present invention will become apparent from the following description of preferred embodiments given in conjunction with the accompanying drawings, in which:

FIG. 1 is a diagram showing the construction of a virtual machine management apparatus for a virtualization-supporting terminal platform in accordance with an embodiment of the present invention;

FIG. 2 is a control flowchart showing operations for exception processing in the virtual machine management apparatus in accordance with the embodiment of the present invention;

FIG. 3 is a conceptual diagram showing the scheduling of two OSs in a virtual machine configuration manager in accordance with the embodiment of the present invention; and

FIG. 4 is a block diagram showing the characteristics of the virtual machine management apparatus and the detailed construction of the virtual machine configuration manager taking charge of the setup of the entire system in accordance with the embodiment of the present invention.

### DETAILED DESCRIPTION OF THE EMBODIMENTS

Hereinafter, embodiments of the present invention will be described in detail with reference to the accompanying drawings which form a part hereof.

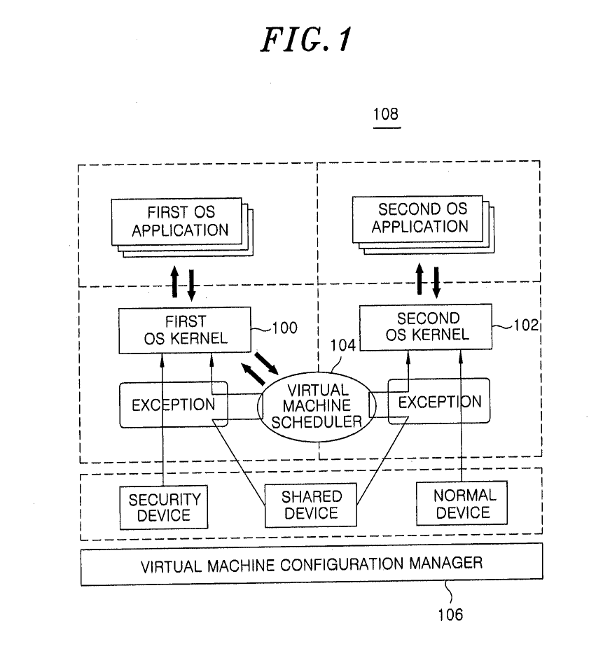

FIG. 1 is a diagram showing the construction of a virtual machine management apparatus in accordance with an embodiment of the present invention. Referring to FIG. 1, the virtual machine management apparatus 108 in accordance with the present invention is operated in a platform for providing two virtual CPU modes in a hardware.

The virtual machine management apparatus 108 includes a first operating system (OS) kernel 100, a second operating system (OS) kernel 102, a virtual machine scheduler 104 and a virtual machine configuration manager 106.

The first OS kernel 100 supports a first OS that runs on a virtualization-supporting terminal platform, and the second operating system (OS) kernel 102 supports a second OS that runs on the virtualization-supporting terminal platform.

Further, virtual machine configuration manager 106, when an exception task is requested based on the first OS or the second OS of the terminal platform, controls processing of the exception task in compliance with a preset policy.

A function provided in a hardware manner is switched to one of two modes using a specific flag, the modes being classified as separate CPU modes. In this case, the modes separately have exception models belonging thereto, and a representative example thereof is a platform for ARM TrustZone. Here, respective virtual CPUs VCPU1 and VCPU2 correspond to the secure mode and the normal mode of ARM.

An exception (such as a Fast Interrupt Request (FIQ), an Interrupt Request (IRQ) or external Abort) provided to each virtual CPU is set to be processed by a virtual machine configuration manager 106 in accordance with the present invention. Additional operations that are performed when a relevant exception is generated, a path through which the exception is to be transferred and the like are determined.

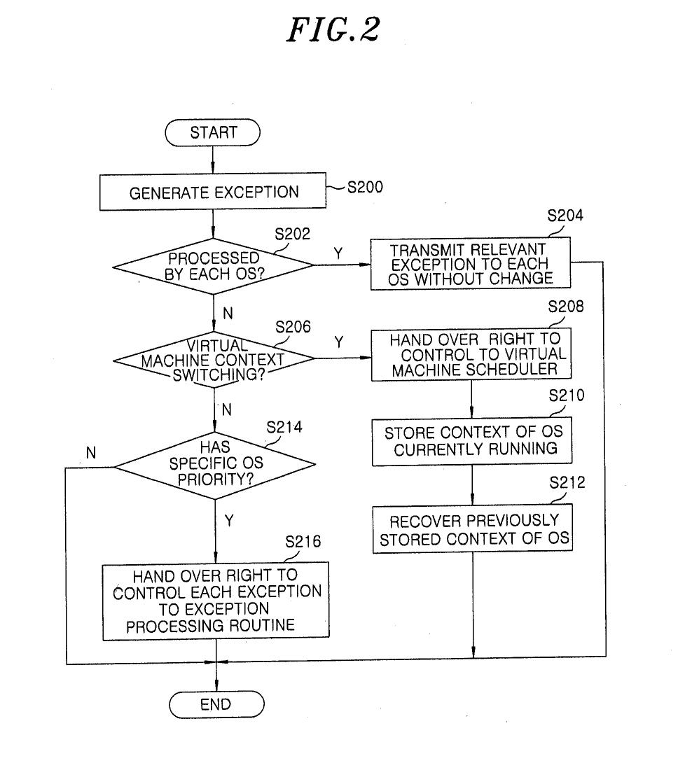

FIG. 2 is a control flow chart showing operations for exception task processing in the virtual machine management apparatus.

Referring to FIG. 2, when an exception is generated in step S200, it is determined whether the exception is to be processed by each of a first OS supported by a first OS kernel 100 and a second OS supported by a second OS kernel 102 in step S202.

If it is determined that the generated exception is to be processed by each of the first OS and the second OS in step S202, the virtual machine configuration manager 106 directly transfers the relevant exception to the OS.

On the other hand, if it is determined that the generated exception is not to be processed by each of the first OS and the second OS in step S202, it is determined whether a virtual machine context switching needs to be performed in step S206.

If it is determined that the virtual machine context switching needs to be performed in step S206, the virtual machine configuration manager 106 hands over a right to control a relevant exception to a virtual machine scheduler 104 which processes the virtual machine context switching, and then switches the context in compliance with a given scheduling policy in step S208.

Thereafter, the context of an OS that is currently running is stored in step S210, and previously stored context of the OS is recovered and then the OS in a waiting state goes back into running in step S212 and then a control process is terminated.

Meanwhile, if it is determined that the virtual machine context switching needs not to be performed in step S206, it is determined whether a specific OS has priority on all exceptions in step S214. If it is determined that the specific OS has the priority on all exceptions in step S214, the virtual machine configuration manager 106 hands over a right to control each exception to the exception processing routine of the specific OS to allow the exception to be processed in step S216, and then the control process is terminated.

On the other hand, if it is determined that the specific OS does not have the priority on all exceptions in step S214, the control process is terminated.

In this case, in the system configuration in which one of two OSs is a Real-Time Operating System (RTOS) having the highest priority, the third method is set and used. Such an exception processing, scheduling and context switching procedure has a fixed execution time and the procedure can predict latency in the level of the entire system.

At least one of two OSs which run on the virtual machine management apparatus of the present invention is executed without being aware of the existence of the virtual machine management apparatus and without undergoing a special modification operation. However, a binary ported to suit a type of relevant CPU that is operating without requiring a virtualization function and a virtual machine must be used.

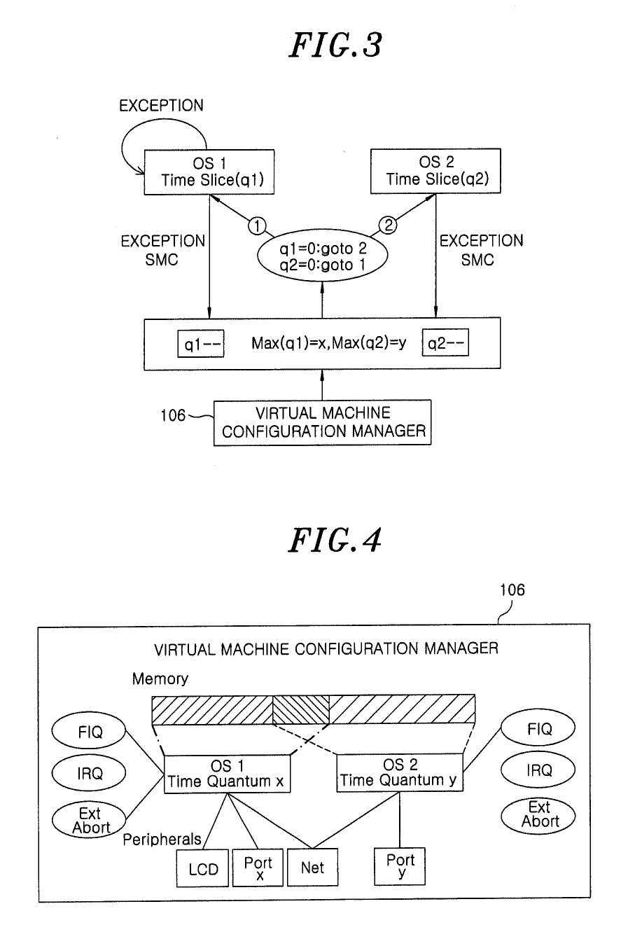

The terminal platform is composed of various types of external devices (peripherals) such as memory, a network device, and an input/output device, in addition to a CPU. In a system configuration step, setup is performed such that some peripherals are shared by two OSs, and a specific peripheral is monopolized by one of the two OSs. This will be described in detail with reference to FIG. 3.

FIG. 3 is a diagram showing the concept of the scheduling of two OSs in the virtual machine configuration manager in accordance with an embodiment of the present invention.

Referring to FIG. 3, a detailed scheduling policy is determined at the step of constructing the entire system in the present invention, and does not change at the time the system is installed and operated. The scheduling policy determined at this step is combined with a scheduling policy designated for each of the two OS and is then operated.

For example, when one OS uses specific static real-time scheduling, virtual machine scheduling is operated without destroying the static real-time scheduling. In this case, the scheduling policy of the virtual machine configuration manager 106 is alternately executed while consuming a time quantum allocated to each OS at periods designated by a timer which manages the entire system. The characteristics of the entire system also change when it is determined which OS has monopolized the timer and when the value of a time quantum allocated to each OS is controlled.

That is, firstly, in a system in which one OS is a Real-Time OS (RTOS) having absolutely high priority, and the other OS is a General Purpose OS (GPOS) having a lower priority and importance level, a sufficient time quantum is allocated to the RTOS so that the RTOS monopolizes the timer (set to be identical to a virtual machine timer), and the time quantum of the GPOS is set to ‘0’. Accordingly, the task of the RTOS is primarily processed, and thereafter the other OS is not allocated a CPU until the RTOS releases a control right and enters a waiting state.

Then, at the time point at which the RTOS hands over the control right to the other OS, the GPOS is provided with a time quantum corresponding to the waiting time of the RTOS, and runs until the control right is handed over again to the RTOS by the timer and the exception of the RTOS.

Secondly, in a system in which two OSs have the same priority, context switching occurs at the time point at which the OSs consume the same time quantum. Thirdly, in other cases, a time quantum is separately designated for each OS, and the frequency of the running of each OS can be controlled.

In this case, the time actually recognized by each OS via the virtual machine configuration manager 106 is different from the actual time by a fixed number in the remaining setup cases other than the setup of RTOS in first case. In the setup of first case, the time of RTOS is identical to the actual time, and the time of GPOS is identical to the sum of the idle times of the RTOS. In order to cause the times of the two OSs to be identical to those of the actual timer, the OSs are designated to share and process an exception (a timer interrupt) in the case of a platform in which a mode (for example, the monitor mode of ARM TrustZone) for managing all of the virtual CPUs is provided. In this case, for the OS in which basic information about exception handler code is provided, the modification of the exception handler code is required, and the OS is semi-automated by the virtual machine configuration manager 106 of FIG. 3.

FIG. 4 is a block diagram showing the characteristics of the virtual machine management apparatus and the detailed construction of the virtual machine configuration manager that takes charge of the setup of the entire system in accordance with an embodiment of the present invention.

Referring to FIG. 4, the virtual machine configuration manager 106 mainly takes charge of three functions including an exception processing method, a virtual machine scheduling, and a resource management.

Firstly, in the exception processing method, TrustZone provides the function of processing each exception such as a Fast Interrupt Request (FIQ), an Interrupt Request (IRQ), or an external abort in the monitor mode, and, in detail, provides the function of determining whether a separate OS will directly process each exception, or whether the virtual machine management apparatus that is executed in monitor mode will process each exception. Here, the exception processing method includes the entire procedure leading to a handler which performs detailed operations for each exception as well as the procedure of determining whether to bypass a relevant exception. Further, for the OS in which basic information about an exception and interrupt processing portion is provided, the modification and setup of the relevant code of the OS are automated to a simple option setup level.

Secondly, the virtual machine scheduling is configured using the scheme described with reference to FIG. 3, wherein time quanta for two OSs are designated. Thirdly, in the resource management, it is determined whether a specific OS will monopolize all resources of the system, such as memory, a storage device, a display, an input device, and a network, or whether two OSs will share the resources. Such determination varies depending on the characteristics of the entire system and the properties of the two OSs.

In this case, detailed values for setup in the three cases of FIG. 4 are combined in various manners, and thus system configuration type options are set in advance in the form of a script and can be applied to the entire system configuration step. In a terminal such as a smart phone in which one OS takes charge of a system that requires the accuracy of time and operations and the other OS is implemented as a system that has a relatively low importance level, but requires a plenty of functions, priority is maximally assigned to the OS which implements virtual machine scheduling, and resources to be mainly used by this OS are caused to be monopolized by the OS. In contrast, resources essential for the two OSs, such as a network device, are designated to be shared by the two OSs. In the case of memory, when there is no interaction between two systems, setup is made such that respective OSs have completely independent areas. However, when there is a need to exchange information between the two systems, a predetermined area can be designated as shared memory.

While the invention has been shown and described with respect to the embodiments, it will be understood by those skilled in the art that various changes and modifications may be made without departing from the scope of the invention as defined in the following claims.

What is claimed is:

1. A virtual machine management apparatus, comprising:
a first Operating System (OS) kernel for supporting a first OS that runs on a virtualization-supporting terminal platform;
a second OS kernel for supporting a second OS that runs on the terminal platform; and
a virtual machine configuration manager for, when an exception task is requested based on the first OS or the second OS of the terminal platform, controlling processing of the exception task in compliance with a preset policy.

2. The virtual machine management apparatus of claim 1, wherein the virtual machine configuration manager performs control such that when the exception task is a task processed by one of the first OS and the second OS, the exception task is applied to the one of the first OS and the second OS and is processed thereby.

3. The virtual machine management apparatus of claim 1, wherein the virtual machine configuration manager performs control such that when the exception task is a task requiring context switching between the first OS and the second OS, context of the first OS or the second OS that is currently running is stored, and context of the first OS or the second OS that was previously stored is recovered, and thus the exception task is processed.

4. The virtual machine management apparatus of claim 1, wherein the virtual machine configuration manager performs control such that when the exception task is requested, and is a task for which priority has been assigned so that the exception task is processed by a specific OS, the exception task is processed by one of the first OS and the second OS, to which priority has been assigned.

5. The virtual machine management apparatus of claim 1, wherein the exception task is one of a Fast Interrupt Request (FIQ), an Interrupt Request (IRQ) and an external abort.

6. A virtual machine management apparatus, comprising:
a first Operating System (OS) kernel for supporting a first OS that runs on a virtualization-supporting terminal platform;
a second OS for supporting a second OS that runs on the terminal platform; and
a virtual machine configuration manager for, when execution of a task is requested based on the first OS or the second OS of the terminal platform, allocating the task to the first OS or the second OS to be processed thereby in compliance with a scheduling policy preset for the first OS or the second OS.

7. The virtual machine management apparatus of claim 6, wherein the virtual machine configuration manager performs control such that when a monopolization right is assigned to the first OS or the second OS as a result of inspection of the scheduling policy, the task is executed at a time point, at which a previous task of the first OS or the second OS to which the monopolization right has been assigned, is terminated.

8. The virtual machine management apparatus of claim 6, wherein the virtual machine configuration manager performs control such that when identical priority is assigned to the first OS and the second OS as a result of inspection of the scheduling policy, the task is executed by an OS which terminates a previous task first.

9. The virtual machine management apparatus of claim 6, wherein the virtual machine configuration manager performs control such that when a monopolization right or identical priority is not assigned to the first or second OS as a result of inspection of the scheduling policy, a time quantum is separately designated for each OS and then the task is performed by each OS.

10. The virtual machine management apparatus of claim 6, wherein the virtual machine configuration manager alternately consumes the time quantum allocated to the first OS or the second OS, and then allocates the task to the first OS or the second OS.

11. A virtualization method using a virtual machine management apparatus, comprising:
receiving an execution task request by a terminal platform which supports virtualization of a first Operating System (OS) and a second OS;
allocating the exception task to the first OS or the second OS in compliance with a preset policy when the exception task request is received; and
executing the execution task based on the first OS or the second OS to which the exception task has been allocated.

12. The virtualization method of claim 11, wherein said allocating the exception task comprises:
inspecting a policy set in the exception task; and
when the exception task is a task processed by any one of the first OS and the second OS, allocating the exception task to the one of the first and the second OS.

13. The virtualization method of claim 11, wherein said allocating the exception task comprises:
inspecting a policy set in the exception task; and
when the exception task is a task requiring context switching between the first OS and the second OS, storing context of the first OS or the second OS which is currently running; and
recovering context of the first OS or the second OS which was previously stored, and allocating the exception task to the recovered context of the first OS or the second OS.

14. The virtualization method of claim 11, wherein said allocating the exception task comprises:
inspecting a policy set in the exception task; and
when the exception task is requested, and is a task for which priority has been assigned so that the exception task is processed by a specific OS, allocating the exception task to one of the first OS and the second OS, to which priority has been assigned.

15. The virtualization method of claim 11, wherein the exception task is one of a Fast Interrupt Request (FIQ), an Interrupt Request (IRQ) and an external abort.

16. A virtualization method using a virtual machine management apparatus, comprising:
receiving a task request by a terminal platform which supports virtualization of a first Operating System (OS) and a second OS;
inspecting a scheduling policy preset for the first OS or the second OS when the task request is received;
allocating the task to the first OS or the second OS in compliance with the scheduling policy; and
executing the task based on the OS to which the task has been allocated.

17. The virtualization method of claim 16, wherein said allocating the task includes allocating the task such that when a monopolization right is assigned to the first OS or the second OS as a result of the inspection of the scheduling policy, the task is executed at a time point, at which a previous task of the first OS or the second OS to which the monopolization right has been assigned, is terminated.

18. The virtualization method of claim 16, wherein said allocating the task includes allocating the task such that when identical priority is assigned to the first OS and the second OS as a result of the inspection of the scheduling policy, the task is executed by an OS which terminates a previous task first.

19. The virtualization method of claim 16, wherein said allocating the task includes allocating the task such that when a monopolization right or identical priority is not assigned to the first or second OS as a result of the inspection of the scheduling policy, a time quantum is separately designated for each OS and then the task is performed by each OS.

20. The virtualization method of claim 16, wherein said allocating the task includes allocating the task such that when a monopolization right or identical priority is not assigned to the first or second OS as a result of the inspection of the scheduling policy, the time quantum allocated to the first OS or the second OS is alternately consumed and then the task is allocated to the first OS or the second OS.
